(19) United States
(12) Patent Application Publication
(10) Pub. No.: US 2022/0073227 A1
(43) Pub. Date: Mar. 10, 2022

(54) DISPENSING MANDREL

(71) Applicant: Johannes MAYRPETER, Sierning (AT)

(72) Inventors: Johannes MAYRPETER, Sierning (AT); Oswald KIENBACHER, Neuzeug (AT)

(73) Assignee: Johannes MAYRPETER, Sierning (AT)

(21) Appl. No.: 17/414,379

(22) PCT Filed: Jan. 10, 2020
(86) PCT No.: PCT/AT2020/060004

§ 371 Date: Jun. 16, 2021

(30) Foreign Application Priority Data
Jan. 14, 2019 (AT) A 50026/2019

(51) Int. Cl. B65B 69/00; B65D 88/16; B65D 90/58

(52) U.S. Cl. CPC B65B 69/0041; B65D 90/585; B65D 88/1668; B65B 69/0075

(57) ABSTRACT

The invention relates to a dispensing mandrel (1) for dispensing material from a flexible bulk goods container, the dispensing mandrel (1) comprising a hollow body (2) which has an upper and a lower opening surface. A tip adjoins the upper end of the hollow body (2), leaving the upper opening of the hollow body (2) at least partially free. The tip is formed by at least three struts (3) which are planar, radially oriented elements which each abut the inner face (16) of the hollow body (2) with the lower outer edge (15) thereof, and meet at the upper end of the dispensing mandrel (1), thereby forming a tip. At least one transverse strut (12), which abuts against the hollow body (2) with the lower edge (13) thereof, projects from each strut (3).

### CROSS-REFERENCE TO RELATED APPLICATIONS

The present application is a national phase application of PCT Application No. PCT/AT2020/060004, filed Jan. 10, 2020, entitled “DISPENSING MANDREL”, which claims the benefit of Austrian Patent Application No. A50026/2019, filed Jan. 14, 2019, each of which is incorporated by reference in its entirety.

### BACKGROUND OF THE INVENTION

### 1. Field of the Invention

The invention relates to a dispensing device in the form of a dispensing mandrel for dispensing bulk goods from flexible bulk goods containers.

### 2. Description of the Related Art

A flexible bulk goods container is a large sack made of fabric or woven plastics, which is known by the term big bag. To quickly completely empty the big bag, it is normally lifted, and the base surface thereof is cut with a knife. To be able to meter the emptying, dispensing devices in the form of a mandrel are known, which dispensing devices pierce the woven plastics from below with their tip, such that said tip penetrates the bulk material. The bulk material can be emptied from the flexible bulk goods container into the dispensing device through openings, wherein the dispensing device comprises a closing mechanism so that the emptying can be started and stopped.

The documents FR 2895728 A3, EP2937291A1, CH409670A and U.S. Pat. No. 3,831,814A relate to the general state of the art.

FR2895728A3 discloses a dispensing device in the form of a dispensing mandrel for big bags. The dispensing mandrel has a cylindrical hollow body, at the upper end thereof a number of struts merge into a tip. At a distance from the struts, the dispensing mandrel has barbs, which protrude from the cylindrical hollow body. The cylindrical hollow body has openings above the barbs. At the lower end, the cylindrical hollow body has a closure, which is formed from two adjoining plates, wherein the upper plate is firmly connected to the cylindrical hollow body and has a central opening and the lower plate is designed as a full-surface plate and is pivotably fixed to the upper plate by means of a threaded bolt. The dispensing mandrel pierces the big bag with the tip, until the barbs penetrate the big bag. The dispensing mandrel is then retracted slightly, such that the barbs abut the fabric of the big bag from the inside. Bulk material can now penetrate into the cylindrical hollow body between the struts and through the openings above the barbs. By pivoting the lower plate about the threaded bolt, the closure is opened, and the bulk material descends through the cylindrical hollow body. Both plates are provided with handles in order to be able to execute the pivoting motion by hand.

EP 2937291 A1 discloses an extension of the device of FR 2895728 A3 to include a filling nozzle, which can be screwed to the upper plate from below as necessary, when the dispensing mandrel has already penetrated. Otherwise, the devices are identical, wherein neither the dispensing mandrel nor the filling nozzle has a satisfactory base.

WO 2018009952 A1 shows a dispensing mandrel having an improved base in order to avoid damage in the area of the plates or the handles of the closure. While the devices of EP 2937291 A1 and FR 2895728 A3 seem to be welded devices made of sheet metal, the parts of the device of WO 2018009952 A1 are plastic parts.

### SUMMARY OF THE INVENTION

The object of the present invention is to provide an improved dispensing mandrel.

To achieve the object, a dispensing mandrel is proposed for dispensing material from a flexible bulk goods container.

The dispensing mandrel for dispensing material from a flexible bulk goods container comprises a hollow body which has an upper and a lower opening surface, with a tip adjoining the upper end of the hollow body, leaving the upper opening of the hollow body at least partially free, wherein the tip is formed by at least three struts which are planar, radially oriented elements which each abut the inner face of the hollow body with the lower outer edge thereof, and meet at the upper end of the dispensing mandrel forming a tip, wherein at least one transverse strut, which abuts against the hollow body with the lower edge thereof, projects from each strut.

Transverse struts preferably adjoin each strut on both sides.

The transverse struts are preferably planar elements in the form of triangles, the shortest side thereof abuts the hollow body and the second shortest side thereof abuts the respective strut.

The transverse struts are preferably attached below the upper opening surface of the hollow body on the inner face of the hollow body.

The transverse struts preferably extend at least over a quarter of the height of the struts.

The transverse struts preferably extend at least over half the height of the struts.

The transverse struts are preferably inwardly displaced with respect to the outer surface or the upper outer edge of the hollow body.

The transverse struts are preferably inwardly displaced with respect to the outer edge extending upwardly and inwardly of the respective strut.

There is preferably a closure at the lower end of the hollow body, which closure has an upper plate and a lower plate which lie planar against one another, wherein the upper plate adjoins the lower opening surface of the hollow body and itself has an opening in extension of the lower opening surface of the hollow body and wherein the lower plate is attached with a bolt to the upper plate and the lower plate can be pivoted about the axis of said bolt, between a first position in which it completely closes the opening of the upper plate and a second position in which the opening of the upper plate is at least partially free.

The struts and the transverse struts are preferably a monolithic plastic injection-moulded part.

The dispensing mandrel preferably has a hollow body which has an upper and a lower opening surface, wherein the upper end of the hollow body projects into the interior of the flexible bulk goods container so that material from the flexible bulk goods container can penetrate through the upper opening surface of the hollow body into the same, wherein there is a closure at the lower end of the hollow body, which closure has an upper plate and a lower plate which lie planar against one another, wherein the upper plate adjoins the lower opening surface of the hollow body and itself has an opening in extension of the lower opening surface of the hollow body and wherein the lower plate is attached with a bolt to the upper plate and the lower plate can be pivoted about the axis of said bolt, between a first position in which it completely closes the opening of the upper plate and a second position in which the opening the upper plate is at least partially free, wherein the lower plate has a structure which forms at least part of the base of the dispensing device, wherein the bolt or the head thereof or the nut of the bolt preferably do not protrude downwardly from the base.

### BRIEF DESCRIPTION OF THE DRAWINGS

The invention is illustrated with reference to drawings:

FIG. 1 shows the dispensing mandrel known from WO 2018009952 A1 in a side view.

FIG. 2 shows the dispensing mandrel according to WO 2018009952 A1 in a perspective view obliquely from above with a closed closure.

FIG. 3 shows a dispensing mandrel according to the invention in a side view.

FIG. 4 shows an injection-moulded body of a dispensing mandrel according to the invention in a perspective view obliquely from above.

FIG. 5 shows a tip of a dispensing mandrel according to the invention in a sectional view.

FIG. 6 shows a detailed view of a strut with preferred transverse struts in the transition area to the hollow body of the dispensing mandrel.

### DETAILED DESCRIPTION

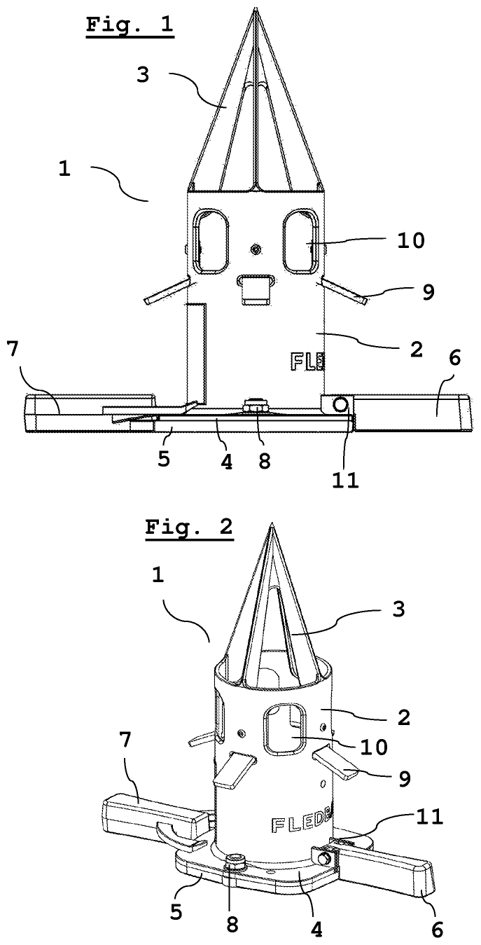

FIGS. 1 and 2 show a dispensing mandrel 1 known from WO 2018009952 A1. The dispensing mandrel of WO 2018009952 A1 preferably serves as a starting point for the present invention, so that a dispensing mandrel according to the invention preferably comprises the features of the dispensing mandrel of WO 2018009952 A1. However, the improvement according to the invention can also be used on other dispensing mandrels.

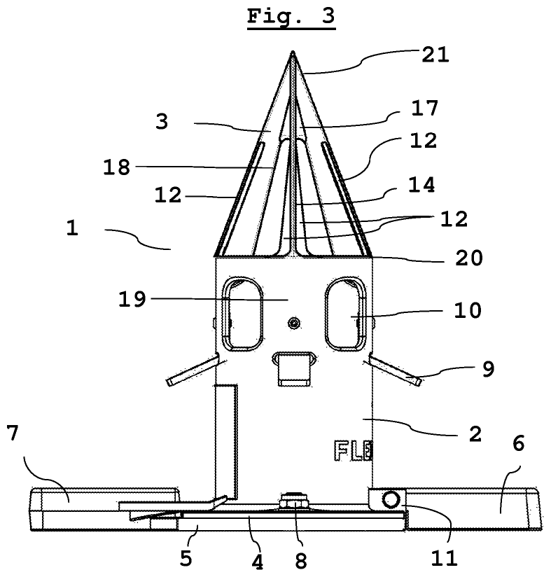

FIG. 3 shows a perspective view of a dispensing mandrel according to the invention. The following paragraphs describe the already known features of the dispensing mandrel 1 with reference to FIG. 1-2.

The dispensing mandrel 1 has a hollow body 2, which preferably has a cylindrical jacket. On the upper end of the hollow body 2, a number of struts 3 merge into a tip. For reasons of stability and due to the preferred production using plastic injection moulding, four struts 3, distributed uniformly over the circumference of the cylinder, have proven to be the most technically favorable variation, as three struts 3 would require a very complex injection mold. At the lower end, the hollow body 2 merges into the upper plate 4, which adjoins the cylinder on the outside and preferably leaves the inner opening of the hollow body 2 entirely open. The hollow body 2, the upper plate 4 and the struts 3 forming the tip are preferably produced a monolithic plastic body using the injection molding procedure. The small curves that are present on the struts 3 on the upper edge of the hollow body 2 are due to the injection molding process.

To make the lower opening of the hollow body 2 or of the upper plate 4 closable, a pivotable lower plate 5 is provided. The upper plate 4 is provided with a handle 6 and the lower plate 5 is provided with a handle 7, which are preferably diametrically opposed in the closed state of the closure. The upper plate 4 and the lower plate 5 each have a borehole, through which the bolt 8 passes, wherein the bolt 8 is pivotably held in at least one of these holes. The lower plate 5 can be pivoted about the axis of the bolt 8, in order to release the opening of the hollow body 2 downwardly.

Between the struts 3 and the upper plate 4, the hollow body 2 has outer barbs 9, which consist of resilient material, such that said barbs are pressed downwards onto the hollow body 2 when piercing the fabric of the big bag so as to not enlarge the opening in the fabric. If the barbs 9 move completely through the fabric, they return to their starting position and spread out against the inner side of the fabric when retracting. The openings 10 in the lateral surface of the hollow body 2 are slightly above the barbs 9, in order to facilitate virtually complete emptying of the big bag. Alternatively, it would also be possible to attach the barbs 9 further up on the hollow body 2, in order to dispense with the openings 10. The barbs 9 are strips of flexible resilient material and are guided inwards through slots in the hollow body 2 and fixed above the slots on the inner side of the hollow body 2 by rivets. The barbs 9 can also be fixed by means of a screw and nut. Relatively solid rubber is suitable as the material.

It can be provided that the upper plate 4 is provided with a structure which forms a part of the base of the dispensing mandrel 1. Alternatively or additionally, it can be provided that the lower plate 5 is provided with a structure which forms a part of the base of the dispensing mandrel 1. The head of the bolt 8 projects maximally as far as the base and is preferably received in a recess of the structure of the lower plate 5. It is sufficient to design the structures as webs on the edge of the relevant plate 4, 5. Alternatively, in the case of the lower plate 5, virtually the entire surface can be provided with the structure, with the exception of the recess for the head of the bolt 8. Particularly good stability is produced when the base formed by the structure has an approximately square circumference. The undersides of the handles 6, 7 can form a level surface with the base, i.e. connect to the structures in a coplanar manner.

At least one of the handles 6, 7, preferably the handle 6, can be foldably fastened. As shown, the handle 6 is pivotably fixed by means of a bolt between two parallel lugs 11 in the transition area between the upper plate 4 and the hollow body 2. The handle 6 can abut the upper plate 4 in the lower position and be upwardly pivotable against the weight force or against a spring force, for example a hinge spring. The handle 6 can alternatively be engaged in the lower position and pressed upwardly out of this position with some resistance. The folding mechanism prevents the handle 6 from breaking under excessive strain.

Particularly good stability is produced when the base formed by the structure of the lower plate 5 has an approximately square circumference. The upper plate 4 preferably has an at least approximately rectangular or preferably square circumference, wherein the lower plate 5 in the closed state covers at least the opening of the upper plate 4 and the corner regions of the at least approximately square circumference and is provided, at least in these corner regions, with a structure which forms the base and/or four supporting legs of the dispensing mandrel 1. By designing the base as a polygon, in particular as a triangle or quadrilateral, there is a significant improvement compared with round or circular bases. The depicted circumference with rounded corners, in which the lateral edges of the square are also outwardly curved, should in particular also be understood as an approximately square perimeter. More generally, the base of the dispensing mandrel 1 or the shape of the structure is non-circular.

Due to the structure 12 extending around the periphery, the stiffness or the bending resistance of the lower plate 5 is increased so that bending of the lower plate 5 is prevented.

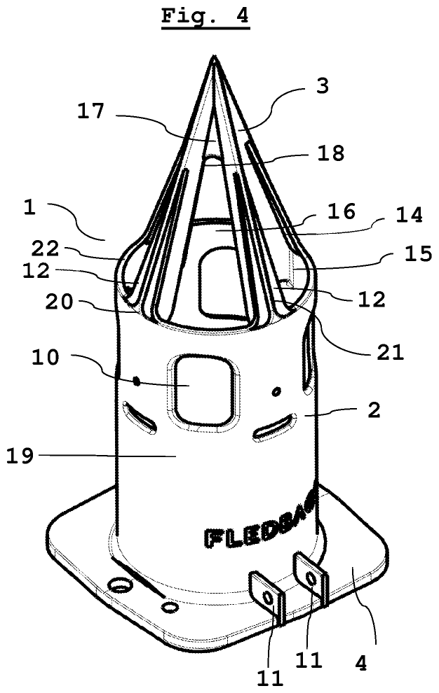

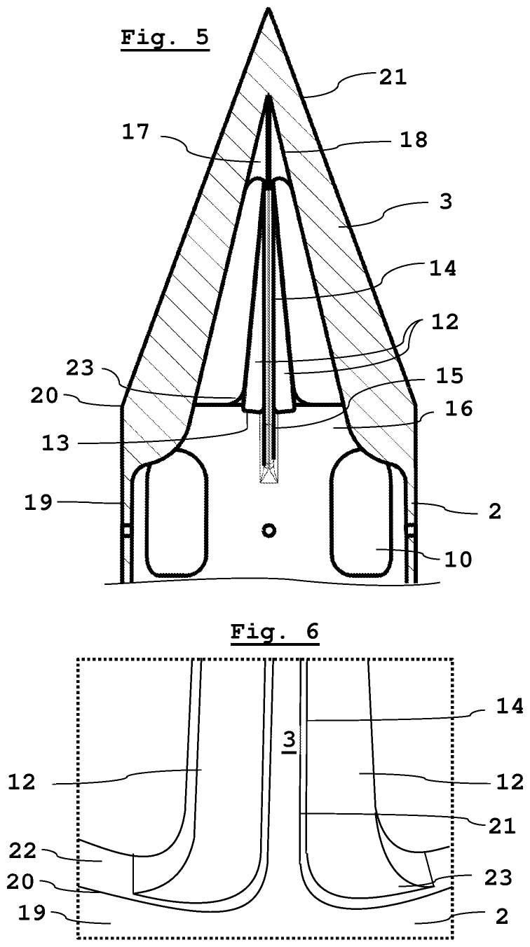

As can be seen from FIGS. 3 to 6, the improvement according to the invention consists of providing additional transverse struts 12 on the struts 3 which form the tip of the dispensing mandrel 1. At least one transverse strut 12 projects from each strut 3, wherein the transverse strut abuts the hollow body 2 with its lower edge 13, and preferably merges into the same. Each transverse strut 12 abuts the respective strut 3 with an edge 14 extending at an upwardly inwardly incline. The struts 3 are each planar or plate-shaped elements, the surfaces of which are radially oriented. Each strut 3 is connected to the inner face 16 of the hollow body 2 via a vertical outer edge 15. Each strut 3 extends upwards and inwards, starting from the hollow body 2, so that the struts 3 meet at the upper end of the dispensing mandrel 1 forming a tip. The tip preferably has an acute angle. A triangular connecting surface 17 preferably extends between two adjacent struts 3, and connects the two struts 3 below the tip in the circumferential direction. The connecting surfaces 17 preferably adjoin the inner edge 18 of the specific strut 3. Preferably three, particularly preferably four struts 3 are present.

At least on one side, preferably on both sides, a transverse strut 12 which projects from the planar strut 3 and connects the same to the hollow body 2, adjoins at least one strut 3, preferably each strut 3. The transverse struts 12 are preferably designed as planar elements in the form of acute triangles, the shortest side thereof abuts the hollow body 2 and the second shortest side thereof abuts the respective strut 3. The transverse struts 12 preferably start below the upper opening of the hollow body 2 on the inner face 16 of the hollow body 2. The transverse struts 12 preferably extend at least over a quarter of the height of the struts 3, preferably over at least half the height of the struts 3. The transverse struts 12 are preferably displaced inwardly with respect to the outer surface 19 or the upper outer edge 20 of the hollow body 2. The transverse struts 12 are preferably inwardly displaced with respect to the outer edge 21 extending upwardly and inwardly of the respective strut 3. The transverse struts 12 preferably merge at the lower end both into the edge 22 of the hollow body 2 and into the inner face 16 of the hollow body 2. A curve 23 is preferably present on the edge between the transverse strut 12 and the edge 22.

There are preferably two mirror-image transverse struts 12 on each strut 3.

The transverse struts 12 preferably project from the struts 3 perpendicularly and/or in the circumferential direction.

The hollow body 2, the struts 3 forming the tip and the transverse struts 12 are preferably produced as a monolithic plastic body using the injection moulding procedure. The monolithic plastic body preferably also comprises the connecting surfaces 17 between the struts 3 and/or the lugs 11.

The claimed technical features according to the invention of the described embodiments can be combined in any manner as part of the activities of a person skilled in the art. The claimed scope of protection is based solely on the combination of features defined in the independent claim.

1-10. (canceled)

11. A dispensing mandrel for dispensing material from a flexible bulk goods container, the dispensing mandrel comprising:
a hollow body which comprises an upper and a lower opening surface, with a tip adjoining an upper end of the hollow body, leaving the upper opening of the hollow body at least partially free, wherein the tip is formed by at least three struts, which are planar, radially oriented elements which each abut an inner face of the hollow body with an lower outer edge thereof, and meet at the upper end of the dispensing mandrel forming the tip,
wherein at least one transverse strut, which abuts against the hollow body with a lower edge thereof, projects from each strut.

12. The dispensing mandrel as claimed in claim 11, wherein transverse struts adjoin each strut on both sides.

13. The dispensing mandrel as claimed in claim 11, wherein the transverse struts are planar elements in the form of triangles, the shortest side thereof abuts the hollow body and the second shortest side thereof abuts the respective strut.

14. The dispensing mandrel as claimed in claim 11, wherein the transverse struts are attached to the inner face of the hollow body below the upper opening of the hollow body.

15. The dispensing mandrel as claimed in claim 11, wherein the transverse struts extend at least over a quarter of the height of the struts.

16. The dispensing mandrel as claimed in claim 11, wherein the transverse struts extend at least over half the height of the struts.

17. The dispensing mandrel as claimed in claim 11, wherein the transverse struts are displaced inwardly with respect to the outer surface or the upper outer edge of the hollow body.

18. The dispensing mandrel as claimed in claim 11, wherein the transverse struts are displaced inwardly with respect to the upwardly and inwardly extending outer edge of the respective strut.

19. The dispensing mandrel as claimed in claim 11, wherein there is a closure at the lower end of the hollow body, which closure has an upper plate and a lower plate which lie planar against one another, wherein the upper plate adjoins the lower opening surface of the hollow body and itself has an opening in extension of the lower opening surface of the hollow body and wherein the lower plate is attached with a bolt to the upper plate and the lower plate can be pivoted about the axis of said bolt, between a first position in which it completely closes the opening of the upper plate and a second position in which the opening the upper plate is at least partially free.

20. The dispensing mandrel as claimed in claim 11, wherein the hollow body, the struts and the transverse struts are a monolithic plastic injection-molded part.
